(19) United States
(12) Patent Application Publication
(10) Pub. No.: US 2026/0067362 A1
(43) Pub. Date: Mar. 5, 2026

(54) METHOD FOR UPGRADING DRIVING AUTOMATION FEATURES AND, A DOMAIN CONTROLLER AND A VEHICLE INCLUDING THE METHOD

(71) Applicant: HON HAI PRECISION INDUSTRY CO., LTD., New Taipei (TW)

(72) Inventors: YING-TING LAN, New Taipei (TW); SHUO-YEN CHUNG, New Taipei (TW)

(21) Appl. No.: 18/822,910

(22) Filed: Sep. 3, 2024

(51) Int. Cl. H04L 67/12; B60W 30/182; B60W 60/00; G06F 8/65

(52) U.S. Cl. CPC H04L 67/12; B60W 60/001; G06F 8/65

(57) ABSTRACT

A method for upgrading driving automation features is provided. The method is applicable to vehicles that include a first controller with a drive-by-wire system. The method includes connecting a second controller to the first controller. The second controller is configured to generate a control command and to send the control command to the first controller. The first controller controls a movement of the vehicle according to the control command by utilizing the drive-by-wire system. In addition, a domain controller and a vehicle using this method are also provided.

### FIELD

The present disclosure generally relates to vehicle driving systems and, more particularly, to a method for upgrading driving automation features, and a domain controller and a vehicle using the method.

### BACKGROUND

Autonomous driving vehicles generally refer to vehicles that can achieve operation with the assistance of an automated driving support system, thus reaching a level where driver assistance is reduced or not needed at all. According to the standards of the Society of Automotive Engineers (SAE) International, autonomous driving technology is classified into six levels, from no automation, assisted driving to full automation, which are Level 0 to Level 5.

In recent years, the autonomous driving technology of various car manufacturers has become widespread to Level 2. With the rapid development of algorithms and the improvement of the computing power of domain controllers, Level 3 autonomous driving technology has become possible, and even Level 4 and Level 5 are within reach. Generally speaking, domain controllers are usually integrated with a Drive-by-Wire (DbW) system. The domain controller is responsible for generating electronic signals that control systems such as power system, braking system, and steering system, and then the DbW system controls the vehicle's power system, braking system, and steering system according to these electronic signals.

However, because the specific design and implementation of the Drive-by-Wire system may vary from one car manufacturer to another, it is not possible to upgrade a vehicle's driving system simply by replacing it with a higher-level domain controller, which makes it difficult for car owners to upgrade their driving systems after purchasing their vehicles.

### SUMMARY

In view of the above, the present disclosure provides a method for upgrading driving automation features. Through the designed data transmission and controller division of labor, an external domain controller may be used to control the original drive-by-wire system of a vehicle, thereby upgrading the driving automation feature of the vehicle.

A first aspect of the present disclosure provides a method for upgrading driving automation features. The method is applicable to a vehicle that includes a first controller with a drive-by-wire system. The method includes connecting a second controller to the first controller, where the second controller is configured to generate and send a control command to the first controller, and the first controller is configured to control the vehicle's movement according to the control command utilizing the drive-by-wire system.

In some implementations of the first aspect, the first controller is configured to communicate with the second controller through at least one standardized format. The format includes at least one of a sensor data standardization format, a vehicle status data standardization format, or a control command standardization format.

In some implementations of the first aspect, the vehicle further includes a first sensor configured to generate first sensor data. The first controller is configured to standardize the first sensor data into standardized first sensor data and to send the standardized first sensor data to the second controller. The second controller is configured to generate the control command based on the standardized first sensor data.

In some implementations of the first aspect, the method further includes installing a second sensor on the vehicle. The second sensor is coupled to the second controller and is configured to generate second sensor data. The second controller is configured to generate the control command based on the second sensor data.

In some implementations of the first aspect, the first controller is configured to execute an upgrade determination process. The upgrade determination process includes detecting whether the first controller is connected to the second controller to obtain a detection result, and operating in either an upgrade mode or a normal mode based on the detection result.

In some implementations of the first aspect, the method further includes updating the first controller to enable the first controller to support the upgrade determination process.

In some implementations of the first aspect, in the upgrade mode, the first controller is configured to receive the control command from the second controller and to control the vehicle's movement by utilizing the drive-by-wire system according to the control command from the second controller. In the normal mode, the first controller is configured to generate a control command and control the vehicle's movement by utilizing the drive-by-wire system according to the control command generated by the first controller.

In some implementations of the first aspect, in the upgrade mode, the first controller is further configured to standardize first sensor data into standardized first sensor data and to send the standardized first sensor data to the second controller.

In some implementations of the first aspect, the first controller includes a driver support system controller, and the second controller includes an autonomous driving system controller.

In some implementations of the first aspect, a driving automation level of the first controller is Society of Automotive Engineers (SAE) Level 2, and a driving automation level of the second controller is one of SAE Level 3, SAE Level 4, or SAE Level 5.

A second aspect of the present disclosure provides a domain controller for a vehicle. The domain controller includes a connection interface, a decision module and a control module. The connection interface is configured to connect to a controller of a vehicle with a drive-by-wire system. The decision module is configured to generate a vehicle control decision based on at least one sensor data corresponding to the vehicle. The control module is configured to generate a control command based on the vehicle control decision. The connection interface is further configured to send the control command to the controller of the vehicle, such that the controller of the vehicle controls of the vehicle's movement according to the control command by utilizing the drive-by-wire system.

In some implementations of the second aspect, the domain controller is configured to communicate with an external controller through at least one standardized format, which includes at least one of a sensor data standardization format, a vehicle status data standardization format, or a control command standardization format.

In some implementations of the second aspect, the connection interface is further configured to receive standardized first sensor data from the controller of the vehicle. The decision module is configured to generate the vehicle control decision based on the standardized first sensor data.

In some implementations of the second aspect, the domain controller further includes a perception module configured to obtain at least one second sensor data from at least one sensor on the vehicle. The decision module is configured to generate the vehicle control decision based on the second sensor data.

In some implementations of the second aspect, the connection interface includes an Ethernet interface.

A third aspect of the present disclosure provides a vehicle. The vehicle includes a first sensor and a first domain controller. The first sensor is configured to generate first sensor data. The first domain controller includes a drive-by-wire system and a connection interface configured to connect to a second domain controller. The first domain controller is configured to detect whether the connection interface is connected to the second domain controller to obtain a detection result and operate in either an upgrade mode or a normal mode based on the detection result. In the upgrade mode, the first domain controller is configured to receive a control command from the second domain controller and control the vehicle's movement by utilizing the drive-by-wire system according to the control command from the second domain controller.

In some implementations of the third aspect, in the normal mode, the first domain controller is configured to generate a control command based on the first sensor data and to control the vehicle's movement by utilizing the drive-by-wire system according to the control command generated by the first domain controller.

In some implementations of the third aspect, in the upgrade mode, the first domain controller is further configured to standardize the first sensor data into standardized first sensor data and to send the standardized first sensor data to the second domain controller.

In some implementations of the third aspect, the vehicle further includes a vehicle control unit configured to obtain a vehicle status. In the upgrade mode, the first domain controller is further configured to standardize the vehicle status into standardized vehicle status data and send the standardized vehicle status data to the second domain controller.

In some implementations of the third aspect, the connection interface includes an Ethernet interface.

Based on the above, the method for upgrading driving automation features and domain controller and vehicle using this method are provided in the implementations the present disclosure. By connecting a second controller to the first controller of the vehicle, enabling communication between the first and second controllers, and allowing the second controller to control the vehicle's existing drive-by-wire system through control commands, the upgrading of driving automation features in vehicles produced by different manufacturers can be achieved.

### BRIEF DESCRIPTION OF THE DRAWING S

FIG. 1 illustrates a block diagram of a vehicle in accordance with an example implementation of the present disclosure.

FIG. 2 illustrates a flowchart of a method for upgrading driving automation features in accordance with an example implementation of the present disclosure.

FIG. 3 illustrates a schematic diagram of a method for upgrading driving automation features in accordance with an example implementation of the present disclosure.

FIG. 4 illustrates a block diagram of a domain controller in accordance with an example implementation of the present disclosure.

### DETAILED DESCRIPTION

The following description contains specific information related to exemplary implementations of the present disclosure. The drawings and their accompanying detailed descriptions in the present disclosure are merely exemplary implementations. However, the present disclosure is not limited to these exemplary implementations. Those skilled in the art will appreciate various modifications and alternative implementations of the present disclosure are possible. Unless otherwise indicated, identical or corresponding elements in the drawings may be indicated by the same or corresponding reference numerals. In addition, the drawings and examples in the present disclosure are generally not drawn to scale and do not correspond to actual relative sizes.

For the sake of consistency and clarity, similar features are labeled with the same reference numerals in the exemplary drawings (although this may not be the case in some examples). However, features in different implementations may differ in other respects, and should not be narrowly interpreted based solely on the features shown in the drawings.

The terms “at least one implementation,” “an implementation,” “multiple implementations,” “different implementations,” “some implementations,” and “the present implementation,” as used herein, may include specific features, structures, or characteristics, but not every possible implementation necessarily includes the particular features, structures, or characteristics. Additionally, the repeated use of phrases such as “in one implementation,” “in the present implementation,” does not necessarily refer to the same implementation, although they may be the same. Furthermore, phrases such as “implementations of the disclosure” associated with the term “the present disclosure” does not mean that all implementations of the disclosure necessarily include particular features, structures, or characteristics and should be understood to mean that “at least some implementations of the disclosure” include the specific features, structures, or characteristics described. The term “coupled” is defined as connected, whether directly or indirectly through intermediate components, and is not necessarily limited to physical connections. When the term “comprising” is used, it means “including but not limited to,” explicitly indicating an open-ended inclusion or relationship of combinations, groups, series, and the like.

Furthermore, specific details such as functional entities, technologies, protocols, standards, etc. have been explained for the purpose of explanation and non-limitation to provide an understanding of the described technology. In other examples, detailed descriptions of well-known methods, technologies, systems, architectures, etc. are omitted to avoid confusing the explanatory description with unnecessary details.

The terms “first,” “second,” and “third,” etc. used in the specification and the accompanying drawings of the present disclosure are intended to distinguish between different objects, rather than to describe a particular order. In addition, the term “comprising” and any variations thereof are intended to cover non-exclusive inclusion. For example, a process, method, system, product, or apparatus that includes a series of steps or modules is not limited to the listed steps or modules but may optionally include additional steps or modules not listed, or optionally include additional steps or modules inherent in such processes, methods, products, or apparatus.

The following description is provided in conjunction with the accompanying drawings to illustrate implementations of the present disclosure.

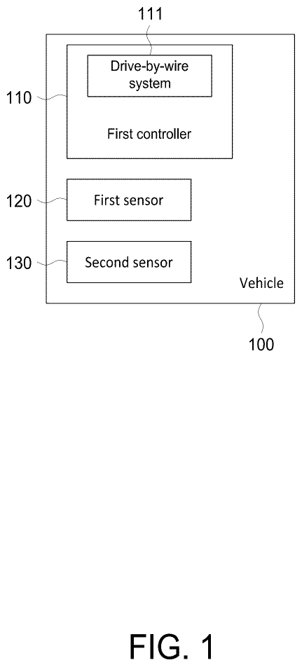

FIG. 1 illustrates a block diagram of a vehicle according to an example implementation of the present disclosure.

The Society of Automotive Engineers (SAE) International categorizes the levels of vehicle driving automation from 0 to 5. Level 0 vehicles have no automation and are entirely controlled by the driver. Level 1 vehicles may provide some basic driving assistance features, such as cruise control and lane keeping, but the driver still needs to continuously monitor and control the vehicle. Level 2 vehicles may perform basic driving tasks like acceleration, braking, and steering, yet the driver must continuously monitor the vehicle and take over control when necessary. Level 3 vehicles may perform automated driving in specific scenarios, such as on highways, allowing the driver to remove hands from the steering wheel, though the driver must be prepared to take control under certain conditions. Level 4 vehicles may operate autonomously in most situations without driver monitoring, but the driver needs to be able to take control in special cases or system failures. Level 5 vehicles may operate fully autonomously in all situations, without driver intervention, and do not have manual controls like a steering wheel, accelerator, or brake pedal. These levels reflect the degree of vehicle automation and the level of driver involvement.

Referring to FIG. 1, the vehicle 100 may include a first controller 110 with a drive-by-wire system 111. Drive-by-wire technology, also known as electronic control driving technology or wire-controlled driving technology, uses electronic components to control various vehicle components, replacing traditional mechanical control methods. The drive-by-wire system 111, for example, uses the aforementioned technology, may include drive-by-wire throttle, brakes, steering, etc., to control a movement of the vehicle 100 through electronic signals.

In some implementations, the vehicle 100 may also include a first sensor 120, which may be a combination of one or more sensors to generate first sensor data. Specifically, the original sensors on vehicle 100 may be considered as the first sensor(s) 120. For example, the first sensor 120 may include one or more or a combination of components such as cameras, millimeter-wave radar, Global Navigation Satellite System (GNSS) receivers, Inertial Measurement Units (IMUs), etc., but the present disclosure is not limited to the examples provided herein.

In some implementations, the first controller 110 may be a domain controller (also referred to as the first domain controller in the present disclosure). For instance, the first controller 110 may be an assisted driving domain controller or a Driver Support System controller. According to SAE's definitions, the driving automation level of such controllers may be SAE Level 1 or SAE Level 2.

In some implementations, the first controller 110 may also include modules such as a perception module, a decision-planning module, and a control module (which are not depicted in the drawings,) but the present disclosure is not limited to the examples provided herein. In detail, the perception module may receive first sensor data from the first sensor 120 and identify the environment around the vehicle 110. The decision-planning module may determine the driving route and speed of the vehicle 110 based on the output of the perception module. The control module may calculate the curvature and acceleration for the next moment of the vehicle 110 to generate control command(s). The drive-by-wire system 111 may control the movement of the vehicle 110 according to the control command(s) from the control module.

It should be noted that one or more modules included in the first controller 110 may be functional modules implemented by software and/or firmware, which are not limited to the examples provided herein. From a hardware perspective, the first controller 110 may receive the first sensor data from the first sensor 120 and generate control command(s) based on the first sensor data, and the drive-by-wire system 111 may control the movement of the vehicle 110 according to the control command(s) from the control module.

In some implementations, vehicle 110 may include a vehicle controller unit (which is not depicted in the drawings,) and the first controller 110 may also include a vehicle status module (which is not depicted in the drawings). The vehicle controller unit, such as a Vehicle Control Unit (VCU), may obtain the vehicle status of vehicle 110. The vehicle status module may obtain the vehicle status from the vehicle controller unit and provide the obtained vehicle status to systems like the perception module, decision-planning module, and drive-by-wire system 111.

For example, the vehicle controller unit may collect and process data from various sensors in a cockpit of the vehicle 110, such as speed sensor(s), wheel speed sensor(s), steering angle sensor(s), temperature sensor(s), etc., and convert the data into real-time information available for the driver or autonomous driving systems, thus generating vehicle status. As such, the vehicle status may include, for example, but not limited to, vehicle speed, wheel speed, steering angle, gear position, battery status, brake status, etc.

In some implementations, to support the method of upgrading driving automation features introduced in the implementations of the present disclosure, the first controller 100 may include a connection interface (not depicted in the drawings) for connection and communication with another controller (e.g., a domain controller).

The following description, in conjunction with the accompanying drawings, will explain the method of upgrading driving automation features according to the implementations of the present disclosure. For example, when the owner of a vehicle 100, which supports driving automation features of SAE Level 2, wishes to upgrade the driving automation features of vehicle 100, the method for upgrading driving automation features introduced in the implementations of the present disclosure may be applied.

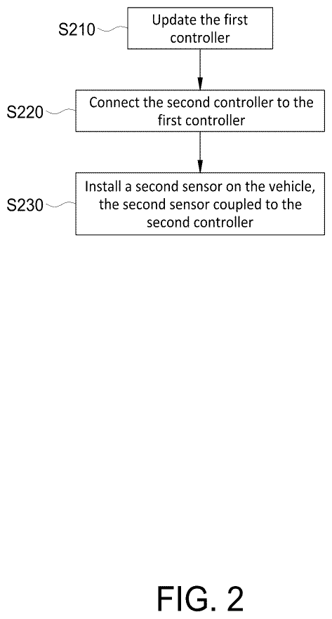

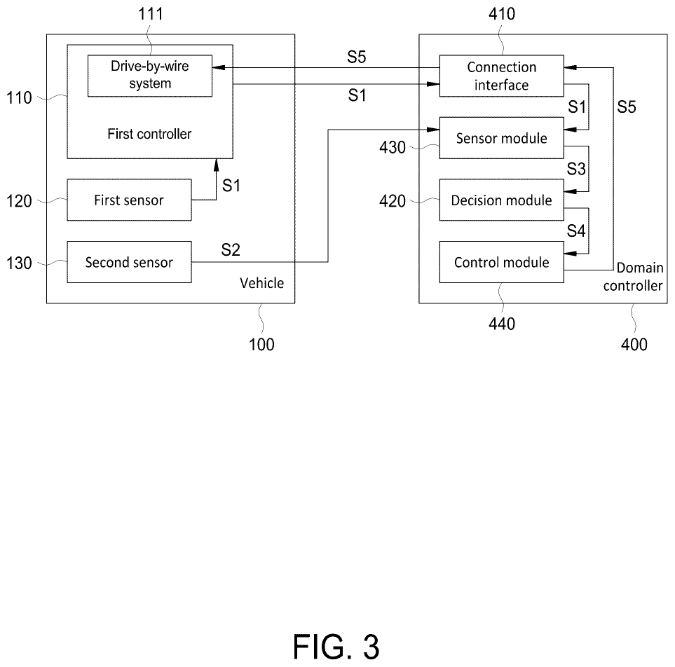

FIG. 2 illustrates a flowchart of a method for upgrading driving automation features in accordance with an example implementation of the present disclosure. FIG. 3 illustrates a schematic diagram of the method in accordance with an example implementation of the present disclosure.

Referring to FIG. 2, in step S210, the first controller 110 may be updated.

In some implementations, the update of the first controller is for supporting an upgrade determination process in the first controller 110. Specifically, the upgrade determination process is used to determine an operating mode of the first controller 110 based on whether it is effectively connected to another controller with a driving automation level not lower than that of the first controller 110.

In some implementations, in a case that the first controller 110 of vehicle 100 already supports the upgrade determination process at the time of manufacture, then step S210 may be omitted.

Referring to FIGS. 2 and 3, in step S220, a second controller 400 may be connected to the first controller 110.

Specifically, the second controller 400 may be an add-on domain controller (also referred to as the second domain controller in the present disclosure). For example, the second controller 400 may be an automated driving domain controller or an automated driving system controller. As defined by SAE International, the driving automation level of such controllers may be SAE Level 3, SAE Level 4, or SAE Level 5. However, the present disclosure is not limited to these levels, as long as the driving automation level of the second controller 400 is not lower than that of the first controller 110, the second controller 400 may be used to upgrade the driving automation features of the vehicle 100.

In some implementations, a communication between the first controller 110 and the second controller 400 may be conducted through Data Distribution Service (DDS) over Ethernet. The details and specific implementations of DDS over Ethernet are known to those skilled in the relevant field, hence are not further described here.

In some implementations, the original first controller 110 of the vehicle may perform the upgrade determination process. In the upgrade determination process, the first controller 110 may detect whether it (e.g., the first controller 110) is connected to the second controller 400 to obtain a detection result and decide to operate in an upgrade mode or a normal mode based on the detection result. For example, when the detection result is that the first controller 110 is connected to the second controller 400, the first controller 110 may switch to the upgrade mode, and when the detection result is that the first controller 110 is not connected to the second controller 400, the first controller 110 may switch to the normal mode.

Specifically, in the upgrade mode, the first controller 110 may receive signal(s) S5 including control command(s) from the second controller 400 and control the movement of the vehicle 100 using the drive-by-wire system 111 based on the control command(s) from the second controller 400. In the normal mode, control command(s) may be generated by the first controller 110 itself, and the first controller 110 may control the movement of vehicle 100 using the drive-by-wire system 111 based on the control command(s). The method for generating control command(s) by the first controller 110 is described in previous paragraphs and is not repeated here.

In some implementations, the first controller 110 and the second controller 400 communicate with each other through at least one standardized format, which may include a sensor data standardization format, a vehicle status data standardization format, and a control command standardization format, but the present disclosure is not limited to the formats provided herein.

In some implementations, when the first controller 110 detects whether it is connected to the second controller, it may also need to determine the validity of the connection, such as but not limited to assessing whether the signal transmission is effective and/or whether the data format of the transmitted information is correct, to obtain a detection result and to determine the operation mode of the first controller 110.

In some implementations, after the first controller 110 receives the first sensor data from the first sensor 120 through signal S1, the first controller 110 may first convert the first sensor data into first standardized sensor data according to the sensor data standardization format and then send the first standardized sensor data to the second controller 400.

In some implementations, the sensor data standardization format may include a standardization format for camera data.

For example, after the first controller 110 receives camera data (e.g., image data) from the first sensor 120, it may detect or identify one or more object information from the camera data, convert the one or more object information into standardized format, and then send it to the second controller 400. The one or more object information may include object detection boundary boxes, road lane line information, traffic sign recognition output, and semantic segmentation results, but the present disclosure is not limited to the examples provided herein.

For example, two-dimensional object detection boundary boxes may be standardized to include contents such as timestamp (e.g., 32-bit floating-point format), application type (e.g., Forward Collision Warning (FCW), Blind Spot Detection (BSD), and/or Traffic Sign Recognition (TSR), string format), object ID (e.g., integer format), boundary box coordinates (e.g., an array of 32-bit floating-point numbers), object name (e.g., string format), and confidence level (e.g., 32-bit floating-point format). The standardization of three-dimensional object detection boundary boxes may be similar, and are not elaborated here.

For example, traffic sign recognition output may be standardized to include contents such as timestamp (e.g., 32-bit floating-point format) and traffic sign information (e.g., traffic sign type and the identified characters within, string format).

For example, road lane line information may be standardized to include contents such as timestamp (e.g., 32-bit floating-point format), road line pixel X-coordinate (e.g., an array of 32-bit floating-point numbers), road line pixel Y-coordinate (e.g., an array of 32-bit floating-point numbers), lane line type (e.g., string format), and confidence level (e.g., 32-bit floating-point format).

For example, semantic segmentation results may be standardized to include contents such as timestamp (e.g., 32-bit floating-point format), category (e.g., a two-dimensional array of unsigned 8-bit integers), confidence level (e.g., a two-dimensional array of unsigned 8-bit integers), and down-sampling factor (e.g., 8-bit integer format).

In some implementations, the sensor data standardization format may include a standardization format for millimeter-wave radar data.

In some implementations, after the first controller 110 receives millimeter-wave radar data (e.g., point cloud data) from the first sensor 120, the first controller 110 may detect or identify point information from the millimeter-wave radar data, convert the point information into standardized format, and then send it to the second controller 400. The point information may include information such as distance, Y-axis offset, and speed, but the present disclosure is not limited to the examples provided herein.

For example, point information may be standardized to include contents such as timestamp (e.g., 32-bit floating-point format) and multiple points (e.g., an array of radar point structures, where the radar point structure includes an ID (e.g., 8-bit integer), distance (e.g., 32-bit floating-point format, in meters), Y-axis offset (e.g., 32-bit floating-point format, in meters), and speed (e.g., 32-bit floating-point format, in meters per second)).

In some implementations, the sensor data standardization format may include a standardization format for navigation satellite system (e.g., Global Navigation Satellite System, GNSS) data.

In some implementations, after the first controller 110 receives navigation satellite system data, the first controller 110 may convert the navigation satellite system data into standardized format and then sends the data to the second controller 400.

For example, the navigation satellite system data may be standardized to include contents such as timestamp (e.g., obtained from the navigation satellite system based on the current position, string format), longitude (e.g., double-precision 64-bit floating-point format, in degrees), latitude (e.g., double-precision 64-bit floating-point format, in degrees), heading angle (e.g., double-precision 64-bit floating-point format, in degrees), horizontal accuracy (e.g., double-precision 64-bit floating-point format, in meters), heading accuracy (e.g., double-precision 64-bit floating-point format, in meters), altitude (e.g., double-precision 64-bit floating-point format, in meters), vertical accuracy (e.g., double-precision 64-bit floating-point format, in meters), speed (e.g., double-precision 64-bit floating-point format, in meters per second), and speed accuracy (e.g., double-precision 64-bit floating-point format, in meters per second).

In some implementations, the sensor data standardization format may include a standardization format for Inertial Measurement Unit (IMU) data.

In some implementations, after the first controller 110 receives IMU data, the first controller 110 may convert the IMU data into standardized format and then send the data to the second controller 400. The IMU data may include acceleration and angular velocity.

For example, acceleration may be standardized to include contents such as timestamp (e.g., 32-bit floating-point format), value in X-direction (e.g., 32-bit floating-point format, in meters per second squared), value in Y-direction (e.g., 32-bit floating-point format, in meters per second squared), and value in Z-direction (e.g., 32-bit floating-point format, in meters per second squared).

For example, angular velocity may be standardized to include contents such as timestamp (e.g., 32-bit floating-point format), value in X-direction (e.g., 32-bit floating-point format, in radians per second), value in Y-direction (e.g., 32-bit floating-point format, in radians per second), and value in Z-direction (e.g., 32-bit floating-point format, in radians per second).

In some implementations, after the first controller 110 receives the vehicle status from the vehicle controller unit, the first controller 110 may first convert the vehicle status into standardized vehicle status data according to the vehicle status data standardization format and then send the data to the second controller 400.

For example, vehicle status may be standardized to include contents such as timestamp (e.g., 32-bit floating-point format), vehicle speed (e.g., 32-bit floating-point format, in meters per second), longitudinal vehicle speed (e.g., 32-bit floating-point format, in meters per second), lateral vehicle speed (e.g., 32-bit floating-point format, in meters per second), longitudinal acceleration (e.g., 32-bit floating-point format, in meters per second squared), lateral acceleration (e.g., 32-bit floating-point format, in meters per second squared), wheel steering angle (e.g., 32-bit floating-point format, in radians), wheel steering speed (e.g., 32-bit floating-point format, in radians per second), wheel speed (e.g., 32-bit floating-point format, in meters per second), left front wheel pulse (e.g., from wheel speed sensor, 32-bit floating-point format, in meters per second), right front wheel pulse (e.g., from wheel speed sensor, 32-bit floating-point format, in meters per second), left rear wheel pulse (e.g., from wheel speed sensor, 32-bit floating-point format, in meters per second), right rear wheel pulse (e.g., from wheel speed sensor, 32-bit floating-point format, in meters per second), yaw rate (e.g., 32-bit floating-point format, in meters per second), brake status (e.g., 32-bit integer format), and gear status (e.g., 32-bit integer format), etc.

In some implementations, after generating control command(s), the second controller 400 may first convert the control command(s) into standardized control command(s) according to the control command standardization format, and then send the command(s) to the first controller 110 through signal S5.

Specifically, the control command standardization format may include at least one of a first control command standardization format and a second control command standardization format. In some implementations, when the control command standardization format includes both the first and the second control command standardization formats, both may be interpreted by the first controller 110 and used to control the operation of vehicle 100 using the drive-by-wire system 111.

For example, control command(s) may be standardized according to the first control command standardization format to include contents such as timestamp (e.g., 32-bit floating-point format), vehicle speed (e.g., 32-bit floating-point format, in meters per second), acceleration (e.g., 32-bit floating-point format, in meters per second squared), front wheel angle (e.g., 32-bit floating-point format, in radians), rear wheel angle (e.g., 32-bit floating-point format, in radians), front wheel angle rotation rate (e.g., 32-bit floating-point format, in radians per second), rear wheel angle rotation rate (e.g., 32-bit floating-point format, in radians per second), and front wheel steering torque (e.g., 32-bit floating-point format, in Newton-meters), etc.

For example, control command(s) may be standardized according to the second control command standardization format to include contents such as timestamp (e.g., 32-bit floating-point format), vehicle speed (e.g., 32-bit floating-point format, in meters per second), curvature (e.g., 32-bit floating-point format, in meters per radian), steering torque (e.g., 32-bit floating-point format, in Newton-meters), etc.

Advantageously, by standardizing the formats used for communication between the first controller 110 and the second controller 400, the second controller 400 may be applied to upgrade the driving automation features of various brands or models of vehicles.

In step S230, a second sensor 130, coupled to the second controller 400, may be installed on the vehicle 100.

In some implementations, the second sensor 130 may be a combination of one or more sensors configured to generate second sensor data. Specifically, if the first sensor 120 of vehicle 100 does not provide sufficient precision or sensing range to meet the upgraded driving automation level (e.g., the level provided by the second controller 400), it is necessary to set up the second sensor 130 on the vehicle 100 and couple the second sensor 130 to the second controller 400. For example, the second sensor 130 may include a combination of sensors such as Light Detection And Ranging (LiDAR), higher-grade or more precise millimeter-wave radar(s), higher-grade navigation satellite system receiver(s), higher-grade or more precise IMUs, or higher-resolution or additional cameras, but the present disclosure is not limited to these.

In some implementations, if the specifications of the first sensor 120 of the vehicle 100 already meet the upgraded driving automation level (e.g., the level provided by the second controller 400), then step S230 may be omitted.

In some implementations, the second controller 400 may be further configured to access High Definition (HD) map data to meet the computational needs of its driving automation features.

In some implementations, the HD map may be stored in the storage element(s) or memory of the second controller 400. However, the present disclosure is not limited to the examples provided herein. In some implementations, the HD map may be stored on a remote server, and the second controller 400 may access and download the HD map data through its network module.

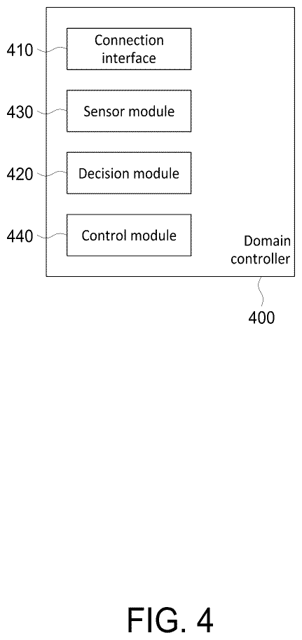

FIG. 4 illustrates a block diagram of a domain controller in accordance with an example implementation of the present disclosure.

Referring to FIGS. 3 and 4, the domain controller 400, for example, may serve as the second controller 400 in the implementations of FIG. 3, and include a connection interface 410, a decision module 420, and a control module 440. Specifically, the domain controller 400 may be configured to connect to the controller of the vehicle 100 (e.g., the original domain controller of the vehicle 100). In some implementations, the domain controller 400 may be connected to the first controller 110 of the vehicle 100, thus enabling the vehicle 100 to achieve an upgrade in driving automation features by connecting to the external domain controller 400.

In some implementations, the connection interface 410 may be an Ethernet interface. Therefore, the domain controller 400 may communicate with the first controller of vehicle 100 via DDS over Ethernet. However, the present disclosure is not limited to the examples provided herein. In other implementations, the connection interface 410 may also be other types of interfaces.

In some implementations, the decision module 420 may be configured to generate vehicle control decision(s) which are associated with the sensor data corresponding to the vehicle 110, and send the vehicle control decision(s) to the control module 440 through signal S4. Specifically, the sensor data corresponding to the vehicle 110 may include at least one of the (standardized) first sensor data and the second sensor data. The vehicle control decision(s) may include the driving route and speed of the vehicle 110. For example, the decision module 420 may generate vehicle control decision(s) based on the (standardized) first sensor data and/or the second sensor data.

In some implementations, the domain controller 400 may further include a perception module 430 configured to obtain sensor data from at least one sensor on the vehicle 100. In some implementations, the perception module 430 may obtain the (standardized) first sensor data from the first sensor 110 transmitted via signal S1 through the connection interface 410. In some implementations, the perception module 430 may obtain the second sensor data transmitted via signal S2 from the second sensor 120. In some implementations, the perception module 430 may obtain both the (standardized) first sensor data and the second sensor data.

In some implementations, the perception module 430 may be configured to identify the environment around the vehicle 110 based on the (standardized) first sensor data and/or the second sensor data and send the identification results to the decision module 420 through signal S3. The decision module 420, for example, may generate vehicle control decision(s) based on the aforementioned identification results and send the vehicle control decision(s) to the control module 440 through signal S4.

In some implementations, the control module 440 may be configured to generate control command(s) based on the vehicle control decision(s) and send the control command(s) in standardized format through the connection interface 410, via signal S5, to the first controller 110 of the vehicle 100. As a result, the first controller 110 of the vehicle 100 may control the movement of the vehicle 100 using the drive-by-wire system 111 based on the control command(s) generated by the second controller 400.

In some implementations, the aforementioned one or more modules included in the domain controller 400 may be functional modules implemented by software and/or firmware, but the present disclosure is not limited to the examples provided herein. Therefore, the modules may be combined, interchanged, or separated according to function. From a hardware perspective, the second controller 400 may receive the (standardized) first sensor data and/or the second sensor data, and generate control command(s) based on the (standardized) first sensor data and/or the second sensor data, and after standardizing the control command(s), send the standardized control command(s) to the first controller 110, so that the first controller 110 may control the movement of the vehicle 100 using the drive-by-wire system 111 based on the control command(s) generated by the second controller 400.

In summary, according to the method for upgrading driving automation features as well as the domain controller and the vehicle applicable to the method provided in the implementations of the present disclosure, a second controller that generates vehicle control decisions is connected to an existing controller on the vehicle, control decisions and commands may be generated by the second controller, and data may then be returned to the original first controller on the vehicle for vehicle motion control. Hence, vehicle owners may conveniently upgrade the driving system of their vehicles that left the factory.

Based on the above description, it is apparent that various techniques may be configured to implement the concepts described in this application without departing from their scope. Furthermore, although certain implementations have been specifically described and illustrated, those skilled in the art will recognize that variations and modifications may be made in form and detail without departing from the scope of the concepts. Thus, the described implementations are to be considered in all respects as illustrative and not restrictive. Moreover, it should be understood that this application is not limited to the specific implementations described above, but many rearrangements, modifications, and substitutions may be made within the scope of the present disclosure.

What is claimed is:

1. A method for upgrading driving automation features, applicable to a vehicle comprising a first controller having a drive-by-wire system, and comprising:
connecting a second controller to the first controller, wherein:
the second controller is configured to generate a control command and to send the control command to the first controller, and the first controller is configured to control a movement of the vehicle according to the control command by utilizing the drive-by-wire system.

2. The method according to claim 1, wherein the first controller is configured to communicate with the second controller through at least one standardized format, and the at least one standardized format comprises at least one of a sensor data standardization format, a vehicle status data standardization format, or a control command standardization format.

3. The method according to claim 1, wherein:
the vehicle further comprises a first sensor configured to generate first sensor data,
the first controller is configured to standardizes the first sensor data into standardized first sensor data and to send the standardized first sensor data to the second controller, and
the second controller is configured to generate the control command based on the standardized first sensor data.

4. The method according to claim 1, further comprising:
installing a second sensor on the vehicle, wherein:
the second sensor is coupled to the second controller and configured to generate second sensor data, and
the second controller is configured to generate the control command based on the second sensor data.

5. The method according to claim 1, wherein the first controller is configured to execute an upgrade determination process, the upgrade determination process comprising:
detecting whether the first controller is connected to the second controller to obtain a detection result; and
operating the first controller in either an upgrade mode or a normal mode based on the detection result.

6. The method according to claim 5, further comprising:
updating the first controller to enable the first controller to support the upgrade determination process.

7. The method according to claim 5, wherein:
in the upgrade mode, the first controller is configured to receive the control command from the second controller and to control the movement of the vehicle by utilizing the drive-by-wire system according to the control command from the second controller; and
in the normal mode, the first controller is configured to generate a control command and to control the movement of the vehicle by utilizing the drive-by-wire system according to the control command generated by the first controller.

8. The method according to claim 7, wherein in the upgrade mode, the first controller is further configured to:
standardize first sensor data corresponding to the vehicle into standardized first sensor data; and
send the standardized first sensor data to the second controller.

9. The method according to claim 1, wherein the first controller comprises a driver support system controller, and the second controller comprises an autonomous driving system controller.

10. The method according to claim 1, wherein a driving automation level of the first controller is Society of Automotive Engineers (SAE) Level 2, and a driving automation level of the second controller is one of SAE Level 3, SAE Level 4, and SAE Level 5.

11. A domain controller, comprising:
a connection interface configured to connect to a controller of a vehicle, the controller having a drive-by-wire system;
a decision module configured to generate a vehicle control decision based on at least one sensor data corresponding to the vehicle; and
a control module configured to generate a control command based on the vehicle control decision, wherein the connection interface is further configured to send the control command to the controller of the vehicle, such that the controller of the vehicle controls a movement of the vehicle according to the control command by utilizing the drive-by-wire system.

12. The domain controller according to claim 11, wherein the domain controller is configured to communicate with an external controller through at least one standardized format, and the at least one standardized format comprises at least one of a sensor data standardization format, a vehicle status data standardization format, or a control command standardization format.

13. The domain controller according to claim 11, wherein the connection interface is further configured to receive standardized first sensor data from the controller of the vehicle, and the decision module is configured to generate the vehicle control decision based on the standardized first sensor data.

14. The domain controller according to claim 11, further comprising:
a perception module configured to obtain at least one second sensor data from at least one sensor on the vehicle, wherein the decision module is configured to generate the vehicle control decision based on the second sensor data.

15. The domain controller according to claim 11, wherein the connection interface comprises an Ethernet interface.

16. A vehicle, comprising:
a first sensor configured to generate first sensor data; and
a first domain controller comprising a drive-by-wire system and a connection interface configured to connect to a second domain controller, the first domain controller configured to:
detect whether the connection interface is connected to the second domain controller to obtain a detection result; and
operate the first domain controller in either an upgrade mode or a normal mode based on the detection result,
wherein in the upgrade mode, the first domain controller is configured to receive a control command from the second domain controller and to control a movement of the vehicle by utilizing the drive-by-wire system according to the control command from the second domain controller.

17. The vehicle according to claim 16, wherein in the normal mode, the first domain controller is configured to generate a control command based on the first sensor data, and to control the movement of the vehicle by utilizing the drive-by-wire system according to the control command generated by the first domain controller.

18. The vehicle according to claim 16, wherein in the upgrade mode, the first domain controller is further configured to standardize the first sensor data into standardized first sensor data and to send the standardized first sensor data to the second domain controller.

19. The vehicle according to claim 16, further comprising:
a vehicle control unit configured to obtain a vehicle status,
wherein in the upgrade mode, the first domain controller is further configured to standardize the vehicle status into standardized vehicle status data and to send the standardized vehicle status data to the second domain controller.

20. The vehicle according to claim 16, wherein the connection interface comprises an Ethernet interface.
